(19) United States
(12) Patent Application Publication
(10) Pub. No.: US 2018/0019995 A1
(43) Pub. Date: Jan. 18, 2018

(54) PORTABLE TERMINAL, METHOD, AND STORAGE MEDIUM HAVING PROGRAM STORED THEREON

(71) Applicant: Konica Minolta, Inc., Tokyo (JP)

(72) Inventors: Akemi Morita, Nara-ken (JP); Takashi Ueda, Tokyo (JP); Shinichi Iizuka, Fukushima-ken (JP)

(73) Assignee: Konica Minolta, Inc., Tokyo (JP)

(21) Appl. No.: 15/647,390

(22) Filed: Jul. 12, 2017

(30) Foreign Application Priority Data
Jul. 13, 2016 (JP) 2016-138656

(51) Int. Cl. H04L 29/06; H04W 12/06; H04W 12/08; G06K 9/00

(52) U.S. Cl. CPC H04L 63/0853; H04W 12/08; H04W 12/06; H04L 63/10; H04L 63/0861; G06K 9/00892; G06K 9/00067; G06K 9/00006

(57) ABSTRACT

A portable terminal includes a hardware processor, a storage, a communication interface that communicates with an external device, and a sensor that detects a subject's biometric information. The external device includes an authentication device that executes an authentication process using the biometric information to authenticate the subject. The external device transmits information based on the authentication process to the terminal authentication to obtain a permission to operate an apparatus. The hardware processor transmits the detected biometric information to the authentication device, receives the authentication information from the authentication device, stores the received authentication information in the storage, sets the storage to a state where the authentication information is readable when a predetermined condition is satisfied, and sets the storage to a state where the authentication information is unreadable when the predetermined condition is not satisfied.

### CROSS REFERENCE TO RELATED APPLICATIONS

Japanese Patent Application No. 2016-138656 filed on Jul. 13, 2016, including description, claims, drawings, and abstract the entire disclosure is incorporated herein by reference in its entirety.

### BACKGROUND

The present invention relates to a portable terminal, a method, and a storage medium having a program stored thereon, and more particularly to a portable terminal communicating with a device which authenticates a subject using the subject's biometric information, a method for controlling the terminal, and a storage medium having a program of the method stored thereon.

Increased awareness of security has resulted in authentication using biometric information or authentication using a combination of biometric information and an ID (identification) or a password, rather than conventional authentication using only an ID and a password. An authentication system using biometric information is disclosed in WO 2002/009034 and WO 2009/096475.

In authentication using biometric information obtained by a sensor, in general, valid biometric information is registered on the side of a device (or PC (personal computer) or a server), and a matching computation using the obtained biometric information and the valid biometric information is performed on the device. This is because the device is equipped with a high-performance computation device (a CPU (central processing unit) and memory) and can perform a complicated computation (high precision computation) for a biometric authentication process at high speed. This allows the sensor to have an inexpensive and simple hardware configuration and the sensor can be miniaturized and less costly.

Furthermore, in recent years, there is a demand to also perform biometric authentication to enhance security when using a large scale on-premises system or cloud service. Registering a user's personal data regarding biometric authentication in a cloud server, however, has a risk of leakage of the user's privacy information.

In view of this, Japanese Laid-Open Patent Publication No. 2002-123778 discloses a method in which a mobile phone obtains biometric information which is in turn matched against biometric information previously stored in the mobile phone. Furthermore, Japanese National Patent Publication No. 2004-518229 discloses a configuration in which a portable personal digital identification device matches biometric information measured by the device against biometric information previously stored in the device and performs authentication.

Furthermore, a system has been proposed in which a portable biometric authentication sensor has biometric information and a computation of matching regarding authentication of biometric information is performed in the biometric authentication sensor. As this system, UAF (Universal Authentication Framework) of FIDO (Fast IDentity Online) is available, for example.

When biometric authentication is performed by a device such as a PC equipped with an authentication sensor and authentication is performed regarding an apparatus for which an authentication result is utilized, it is necessary to take the device out of a bag or the like whenever authentication is performed for the apparatus, which is cumbersome.

Furthermore, when authentication is performed in the authentication sensor and the apparatus is authenticated using an authentication result, the authentication sensor needs to have a high-performance computing unit (a CPU (central processing unit), resulting in high cost. Furthermore, when authentication is performed with a low performance CPU, an excessively long period of time is consumed for the authentication process.

### SUMMARY

One or more embodiments of the present invention provide a portable terminal that is easy to use, a method for controlling the same, and a storage medium having a program of the method stored thereon. One or more embodiments of the present invention provide a portable terminal requiring a short period of time for an authentication process, a method for controlling the same, and a storage medium having a program of the method stored thereon.

According to one or more embodiments of the present invention, a portable terminal reflecting includes a hardware processor, a storage, a communication interface for communicating with an external device, and a sensor for detecting biometric information of a user.

The external device includes an authentication device which performs an authentication process using the biometric information to authenticate the subject and transmits to the terminal authentication information based on the authentication process for obtaining a permission to operate an apparatus to be operated.

The hardware processor transmits the detected biometric information to the authentication device, receives the authentication information from the authentication device, stores the received authentication information to the storage, sets the storage to a state in which the authentication information is readable when a predetermined condition is satisfied, and sets the storage to a state in which the authentication information is unreadable when the predetermined condition is unsatisfied.

According to one or more embodiments of the present invention, a method for controlling a portable terminal is provided. The terminal includes a storage and a communication interface. The method includes communicating with an authentication device via the communication interface. Furthermore, the authentication device performs an authentication process using biometric information of a subject and transmits to the terminal authentication information based on that authentication process for obtaining a permission to operate an apparatus to be operated.

The method further includes: detecting the subject's biometric information; transmitting the detected biometric information to the authentication device via the communication interface; storing to the storage the authentication information received from the authentication device; when a predetermined condition is satisfied, setting the storage to a state in which the authentication information is readable; and when the predetermined condition is unsatisfied, setting the storage to a state in which the authentication information is unreadable.

According to one or more embodiments of the present invention, a storage medium includes a program non-transiently stored thereon for causing a computer to execute a method for controlling a portable terminal.

The terminal includes a storage and a communication interface. The method includes communicating with an authentication device via the communication interface.

Furthermore, the authentication device performs an authentication process using biometric information of a subject and transmits to the terminal authentication information based on that authentication process for obtaining a permission to operate an apparatus to be operated.

The method further includes: detecting the subject's biometric information; transmitting the detected biometric information to the authentication device via the communication interface; storing to the storage the authentication information received from the authentication device; when a predetermined condition is satisfied, setting the storage to a state in which the authentication information is readable; and when the predetermined condition is unsatisfied, setting the storage to a state in which the authentication information is unreadable.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 shows a configuration of an authentication system 1 according to a first example of one or more embodiments.

FIG. 2 shows a specific example of a hardware configuration of a biometric authentication sensor 300 according to the first example of one or more embodiments.

FIG. 3 shows a specific example of a hardware configuration of a mobile terminal 200 according to the first example of one or more embodiments.

FIG. 4 shows a specific example of a hardware configuration of an apparatus 100 according to the first example of one or more embodiments.

FIG. 5 shows an example of a configuration of a function of biometric authentication sensor 300 according to the first example of one or more embodiments.

FIG. 6 shows an example of a configuration of a function of mobile terminal 200 according to the first example of one or more embodiments.

FIG. 7 is a flowchart of an authentication process according to the first example of one or more embodiments.

FIG. 8 is a flowchart of an authentication process according to the first example of one or more embodiments.

FIG. 9 schematically shows data transmitted and received between devices according to the first example of one or more embodiments.

FIG. 10 shows a specific example of a hardware configuration of a biometric authentication sensor 300A according to a second example of one or more embodiments.

FIG. 11 shows a specific example of a hardware configuration of a mobile terminal 200A according to the second example of one or more embodiments.

FIG. 12 shows an example of a configuration of a function of biometric authentication sensor 300A according to the second example of one or more embodiments.

FIG. 13 shows an example of a configuration of a function of mobile terminal 200A according to the second example of one or more embodiments.

FIG. 14 is a flowchart of an authentication process according to the second example of one or more embodiments.

FIG. 15 schematically shows data transmitted and received between devices according to the second example of one or more embodiments.

### DETAILED DESCRIPTION

Hereinafter, embodiments of the present invention will be described with reference to the drawings. However, the scope of the invention is not limited to the disclosed embodiments. In the following description, identical parts and components are identically denoted. Their names and functions are also identical.

One or more embodiments of the present invention are outlined as follows:

A control unit of a portable biometric authentication sensor 300 (a terminal) receives authentication information from an authentication device (a mobile terminal 200) and stores the information to a storage. When a predetermined condition is satisfied, biometric authentication sensor 300 sets the storage to a state in which the authentication information is readable, whereas when the condition is unsatisfied, biometric authentication sensor 300 sets the storage to a state in which the authentication information is unreadable.

Biometric authentication sensor 300 is portable, and thus easy to use. Furthermore, an authentication process is performed by the authentication device, which is external to biometric authentication sensor 300, and biometric authentication sensor 300 does not need to store a program and data (such as biometric information of a user for authentication) for the authentication process. As a result, it is possible to reduce resources (storage capacity, processing performance, etc.) required for biometric authentication sensor 300. Furthermore, as biometric authentication sensor 300 and mobile terminal 200 cooperatively perform the authentication process, a period of time required for the authentication process can be reduced while biometric authentication sensor 300 has such a simple configuration.

While in one or more embodiments a fingerprint image is indicated as biometric information, the biometric information is not limited to the fingerprint image. For example, it may be an image of a vein pattern, an image of an iris pattern, or the like.

Furthermore, in one or more embodiments, “information of a fingerprint image” includes the fingerprint image and/or a feature value of the fingerprint image.

<System Configuration>

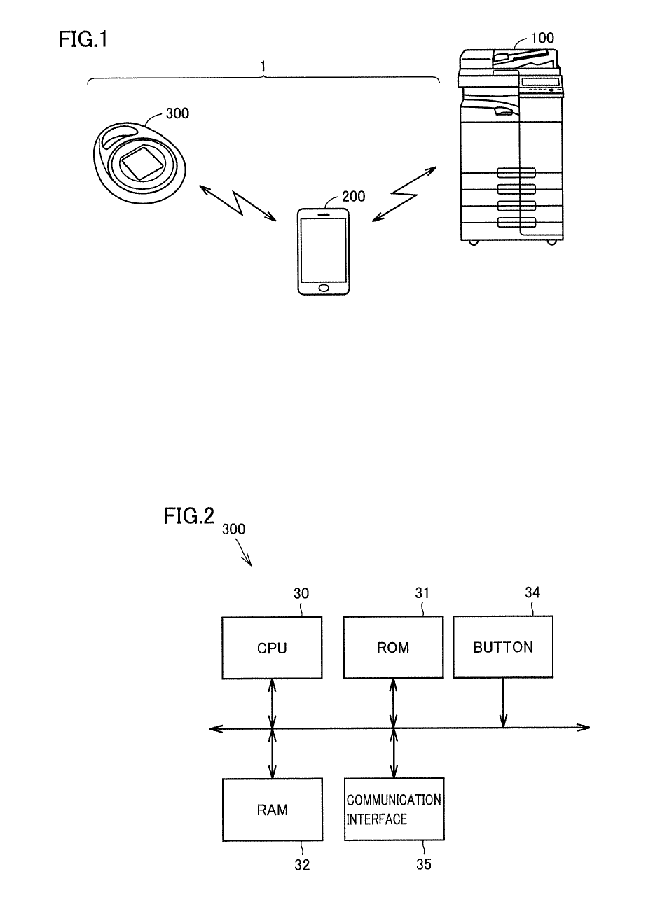

FIG. 1 shows a configuration of an authentication system 1 according to a first example of one or more embodiments. Referring to FIG. 1, authentication system 1 includes a portable biometric authentication sensor 300 (corresponding to a portable terminal) and a mobile terminal 200 (corresponding to an authentication device) that communicates with biometric authentication sensor 300. Biometric authentication sensor 300 and mobile terminal 200 are both examples of an authentication device having an authentication function using biometric information.

In authentication system 1, mobile terminal 200 and biometric authentication sensor 300 can be carried by a single user (or subject). Mobile terminal 200 obtains biometric information and performs an authentication process using the obtained biometric information to authenticate the user. An apparatus 100 (corresponding to a target device) permits the user to use or operate apparatus 100, including a login operation, based on a result of the authentication process. While in the first example of one or more embodiments, apparatus 100 is an image processing apparatus (for example, a copier, a printer, an MFP (Multi-Function Peripherals) or the like), apparatus 100 is not limited in type to the image processing apparatus. For example, it may be a system which manages permission/prohibition of entry.

Biometric authentication sensor 300 is a wearable miniaturized terminal such as a pendant type, a wristwatch type, a bag accessory type or the like. Biometric authentication sensor 300 communicates with mobile terminal 200 by short-range wireless communication. While this short-range wireless communication follows, for example, the BLE (Bluetooth Low Energy) system which enables communication with extremely low power, the communication system is not limited to BLE. Furthermore, mobile terminal 200 or biometric authentication sensor 300 wirelessly communicates with apparatus 100. This wireless communication includes short-range wireless communication such as the NFC (Near Field Radio Communication) system, for example.

<Configuration of Biometric Authentication Sensor 300>

FIG. 2 shows a specific example of a hardware configuration of biometric authentication sensor 300 according to the first example of one or more embodiments. Referring to FIG. 2, biometric authentication sensor 300 includes a CPU (Central Processing Unit) 30 corresponding to a control unit for generally controlling the sensor, a ROM (Read Only Memory) 31, a RAM (Random Access Memory) 32, a button 34 operated to receive from a user an instruction directed to biometric authentication sensor 300, and a communication interface 35 to control wireless communication. ROM 31 and RAM 32 store a program executed by CPU 30 and data. Communication interface 35 includes a circuit for performing wireless communications via an antenna (not shown). Specifically, communication interface 35 includes a modem circuit, an amplification circuit, etc. for communications according to BLE and communications according to NFC.

<Configuration of Mobile Terminal 200>

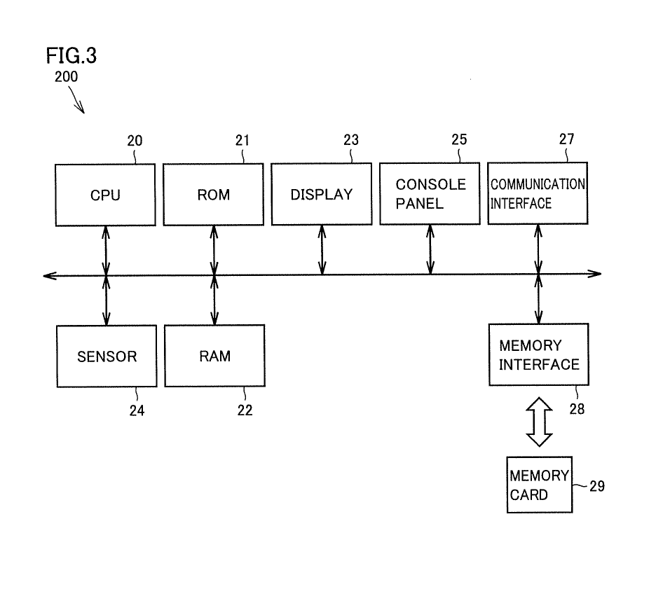

FIG. 3 shows a specific example of a hardware configuration of mobile terminal 200 according to the first example of one or more embodiments. With reference to FIG. 3, mobile terminal 200 includes a CPU 20 corresponding to a control unit generally controlling the mobile terminal, a ROM 21 and a RAM 22 for storing a program executed by CPU 20 and data, a display 23, a sensor 24 for detecting biometric information, an operation panel 25 operated by a user to input information to mobile terminal 200, a communication interface 27, and a memory interface 28. Communication interface 27 includes a circuit for performing wireless communications via an antenna (not shown). Specifically, communication interface 27 includes a modem circuit, an amplification circuit, etc. for communications according to BLE and communications according to NFC. Display 23 and operation panel 25 may be integrally configured as a touch panel.

Sensor 24 includes a plurality of electrodes, a measurement circuit that measures electrostatic capacity varying with a distance between a surface of a finger placed on a surface of the sensor and the electrodes, and a conversion circuit providing conversion from the measured electrostatic capacity to data of a fingerprint image. The method for obtaining data of a fingerprint image is not limited to the method based on the variation of the electrostatic capacity, and it may be a method of obtaining a fingerprint image via an image pickup device such as a CCD (Charge Coupled Device), for example.

Memory interface 28 allows a memory card 29 to be detachably attached thereto. Memory interface 28 includes a circuit controlled by CPU 20 to write/read data to/from memory card 29.

<Configuration of Apparatus 100>

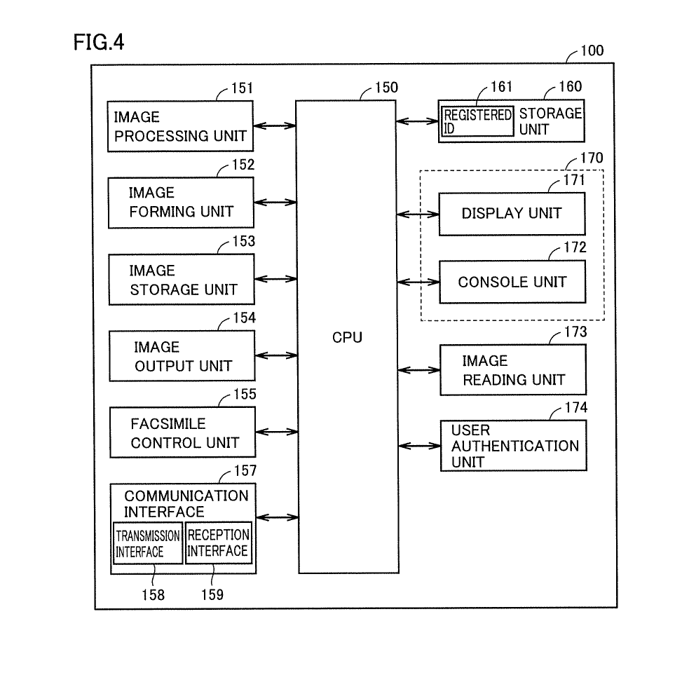

FIG. 4 shows a specific example of a hardware configuration of apparatus 100. In FIG. 4, for example, a configuration of an MFP is shown as apparatus 100. With reference to FIG. 4, apparatus 100 includes a CPU (Central Processing Unit) 150 for generally controlling the apparatus, a storage 160 for storing a program and data, an image storage 153 for mainly storing image data, an information input/output unit 170, a communication interface 157 for communicating with an external device including mobile terminal 200 or biometric authentication sensor 300, a user authentication unit 174, and a variety of processing units.

Storage 160 stores a program executed by CPU 10 and a variety of data. The data stored in storage 160 includes registered ID 161. Registered ID 161 indicates information registered to identify a user (or operator) of apparatus 100 as a valid user. Input/output unit 170 includes a display 171 including a display, and a console 172 operated by a user to input information to apparatus 100. Display 171 and console 172 may be integrally configured as a touch panel.

User authentication unit 174 performs an authentication process for a user of apparatus 100. Communication interface 157 includes a transmission interface 158 including a modulation circuit including an encoding circuit for transmitting data to an external device according to NFC or BLE, and a reception interface 159 including a demodulation circuit including a decoding circuit for receiving data from an external device according to NFC or BLE.

The variety of processing units include an image processor 151, an image forming unit 152, an image output unit 154, a facsimile controller 155 for controlling a facsimile function, and an image reader 173 for optically reading an original placed on a platen (not shown) to obtain image data. These various processing units read and write image data of image storage 153. Note that a function of each unit included in the variety of processing units is well known, and accordingly, it will not be described redundantly in detail.

<Configuration of Function of Biometric Authentication Sensor 300>

FIG. 5 shows an example of a configuration of a function of biometric authentication sensor 300 according to the first example of one or more embodiments. Biometric authentication sensor 300 of FIG. 5 includes a first communication control unit 301 for controlling communications performed via communication interface 35, a control unit 302, and a storage 305 corresponding to ROM 31 or RAM 32. Storage 305 includes a storage area in which authentication information 307 is stored, a reading unit 303 which reads data from the storage area, and a writing unit 304 which writes data to the storage area. Authentication information 307 indicates validity of a subject, based on the authentication process done by mobile terminal 200 using the subject's biometric information.

Control unit 302 controls reading unit 303 and writing unit 304. Control unit 302 includes a determination unit 308 to determine whether storage 305 should be set to a state in which authentication information 307 is readable or a state in which authentication information 307 is unreadable.

First communication control unit 301 performs pairing with mobile terminal 200 via communication interface 35 and establishes a connection. First communication control unit 301 thereafter continues the pairing to maintain that connection. Furthermore, first communication control unit 301 receives from mobile terminal 200 an authentication result provided by an authentication unit 202, which will be described later. Furthermore, first communication control unit 301 transmits authentication information 307 to apparatus 100.

A function of each unit of FIG. 5 corresponds to a program stored in ROM 31 of biometric authentication sensor 300, or a combination of a program and a circuit. When CPU 30 reads these programs from ROM 31 and executes a read program, a function of each unit is implemented. This circuit includes a hardware processor (CPU 20, CPU 30) or ASIC (Application Specific Integrated Circuit) or FPGA (Field-Programmable Gate Array) or the like.

<Configuration of Function of Mobile Terminal 200>

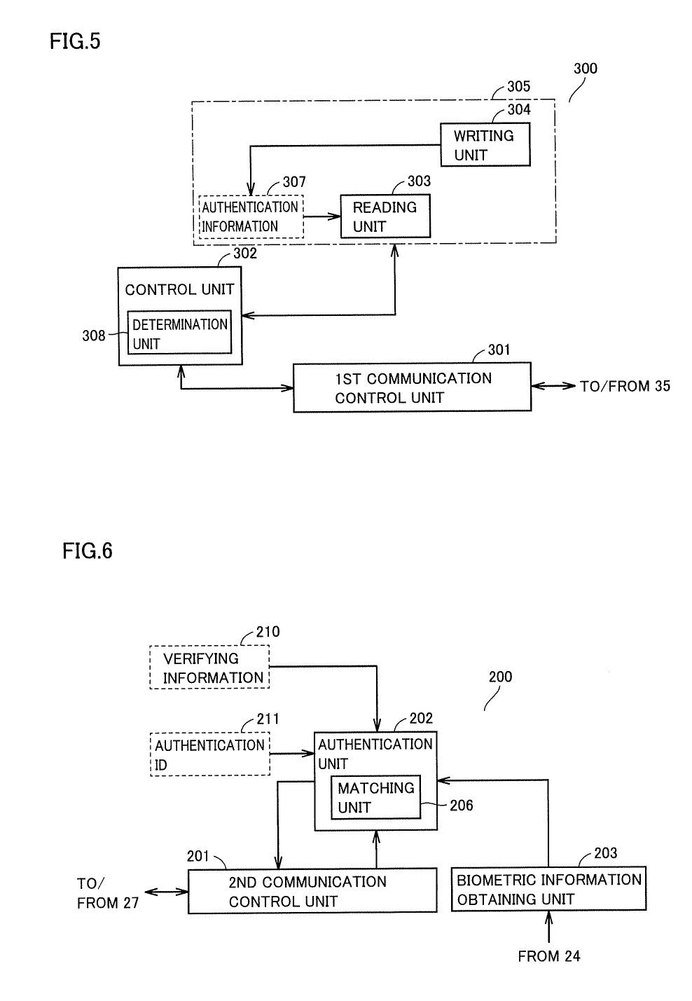

FIG. 6 shows an example of a configuration of a function of mobile terminal 200 according to the first example of one or more embodiments. Referring to FIG. 6, in mobile terminal 200, verifying information 210 and an authentication ID 211 are stored in a storage (ROM 21 or RAM 22). Verifying information 210 includes a fingerprint image of a valid user of mobile terminal 200 and biometric authentication sensor 300. Authentication ID 211 indicates information for identifying a user of mobile terminal 200 or biometric authentication sensor 300 as a valid user of apparatus 100. Mobile terminal 200 includes authentication unit 202, a second communication control unit 201 which controls communication interface 27, and a biometric information obtaining unit 203 which obtains a fingerprint image from an output of sensor 24. Biometric information obtaining unit 203 obtains a fingerprint image by processing such as removing noise from an output of sensor 24 or the like. Furthermore, biometric information obtaining unit 203 can also extract a feature value, which will be described later, from a fingerprint image.

Second communication control unit 201 performs pairing with biometric authentication sensor 300 via communication interface 27 and establishes a connection. Second communication control unit 201 thereafter continues the pairing to maintain the connection. Furthermore, second communication control unit 201 transmits authentication ID 211 to biometric authentication sensor 300.

Authentication unit 202 includes a matching unit 206. Matching unit 206 matches a fingerprint image obtained by biometric information obtaining unit 203 against a fingerprint image of verifying information 210. From a result of the matching process done by matching unit 206, authentication unit 202 calculates a similarity of the fingerprint image sensed by sensor 24 and the fingerprint image of verifying information 210. For a similarity equal to or greater than a threshold value, authentication unit 202 transmits authentication ID 211 to biometric authentication sensor 300 via second communication control unit 201, whereas for a similarity less than the threshold value, authentication unit 202 skips a process for transmitting authentication ID 211 (i.e., omits and does not perform the process). Accordingly, in that case, authentication ID 211 is not transmitted to biometric authentication sensor 300.

A function of each unit of FIG. 6 corresponds to a program stored in ROM 21 of mobile terminal 200, or a combination of a program and a circuit or circuitry. When CPU 20 reads these programs from ROM 21 and executes a read program, a function of each unit is implemented. The circuit or circuitry includes ASIC or FPGA or a hardware processor corresponding to CPU 20 or the like.

<Matching Process>

In one or more embodiments of the present invention, a main matching process for matching a fingerprint image for authenticating a user includes for example a pattern matching method in which fingerprint images are compared (or matched), a feature point extraction method (a minutiae method) allowing a matching process to be done with higher precision than the pattern matching method, and a frequency analysis method allowing a matching process to be done with higher precision than the feature point extraction method. The feature point extraction method is a method of extracting feature values from fingerprint images (attributes of end points or branch points of fingerprints, their relative positional relationship, etc.) and comparing the extracted feature values with each other. In the feature point extraction method, a process of extracting a feature (or feature value) from a fingerprint image is required as a process before the matching process. The frequency analysis method is combined with the minutiae method and thus applied to hybrid authentication. Note that the matching method is not limited to these methods.

Matching unit 206 according to the first example of one or more embodiments performs any one of the matching processes of the above types or a combination of two or more types thereof.

<Flowchart of Process>

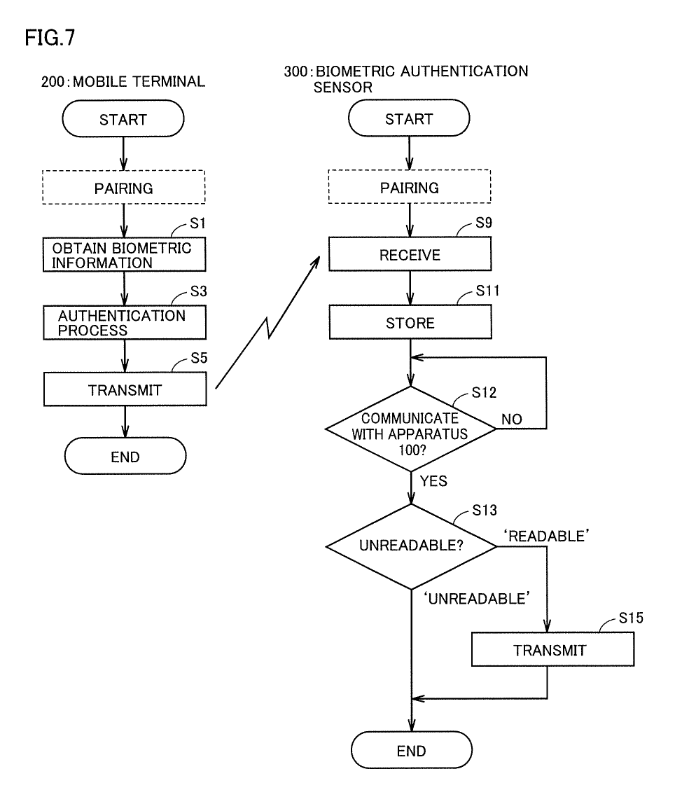

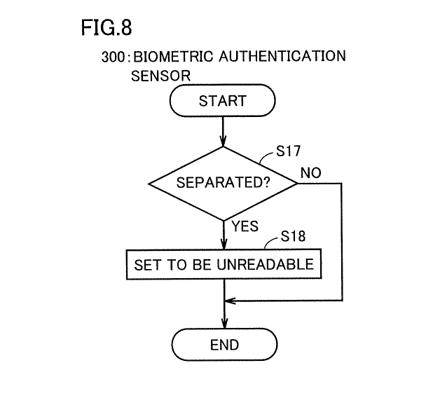

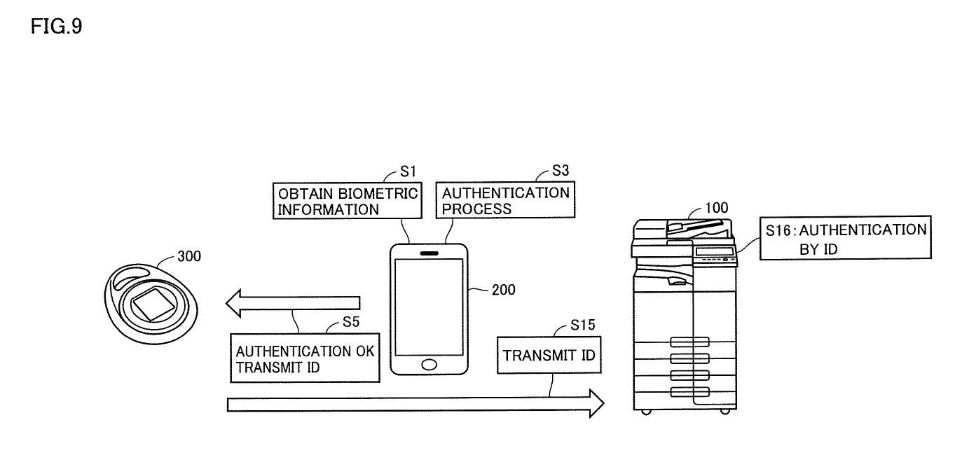

FIGS. 7 and 8 are a flowchart of an authentication process according to the first example of one or more embodiments. FIG. 9 schematically shows data transmitted and received between devices according to the first example of one or more embodiments. With reference to FIG. 7 to FIG. 9, the authentication process according to the first example of one or more embodiments will be described.

(Authentication Process by Mobile Terminal 200)

With reference to FIG. 7, a case will be described in which mobile terminal 200 performs an authentication process and notifies biometric authentication sensor 300 of an authentication result. Initially, first communication control unit 301 of biometric authentication sensor 300 and second communication control unit 201 of mobile terminal 200 start pairing, and establish communication (or connection). Once the communication has been established, the pairing is continuously performed to maintain the connection. The pairing is started when a predetermined operation is performed via button 34 of biometric authentication sensor 300 or when a predetermined operation is performed via operation panel 25 of mobile terminal 200.

Note that when the pairing is started, authentication information 307 of biometric authentication sensor 300 is an initial value (null or undefined).

Sensor 24 of mobile terminal 200 detects biometric information (fingerprint image) of a user. Biometric information obtaining unit 203 obtains a fingerprint image from an output of sensor 24 (step S1 in FIGS. 7 and 9).

Authentication unit 202 performs an authentication process using the obtained biometric information (or fingerprint image) (step S3 of FIG. 7 and FIG. 9). In the authentication process, based on a similarity between fingerprint images indicated by a result of the matching process done by matching unit 206, authentication unit 202 determines whether the fingerprint image obtained via sensor 24 indicates a fingerprint image of a valid user of mobile terminal 200.

Authentication unit 202 transmits a result of the authentication process to biometric authentication sensor 300 via second communication control unit 201 (step S5 of FIG. 7 and FIG. 9). Specifically, when authentication unit 202 determines that the similarity is equal to or greater than a threshold value, in other words, when authentication unit 202 determines that the fingerprint image obtained via sensor 24 indicates a fingerprint image of a valid user of mobile terminal 200, authentication unit 202 transmits authentication ID 211 to biometric authentication sensor 300 together with notification indicating “authentication=OK.”

In contrast, when authentication unit 202 determines that the similarity is less than the threshold value, in other words, when authentication unit 202 determines that the fingerprint image obtained via sensor 24 does not indicate a fingerprint image of a valid user of mobile terminal 200, authentication unit 202 transmits notification indicating “authentication=NG” to biometric authentication sensor 300 via second communication control unit 201 (step S5 of FIG. 7 and FIG. 9).

In biometric authentication sensor 300, first communication control unit 301 receives an authentication result of authentication unit 202 from mobile terminal 200 (step S9).

When control unit 302 determines that the information received from mobile terminal 200 indicates “authentication=OK,” control unit 302 controls writing unit 304 to write authentication ID 211 included in the received information to the storage as authentication information 307 (Step S11). When control unit 302 determines that the received information indicates “authentication=NG,” control unit 302 does not perform writing the received information.

CPU 31 of biometric authentication sensor 300 determines, based on an output from button 34, whether communication with apparatus 100 is indicated (step S12). When CPU 31 determines that communication with apparatus 100 is not indicated (NO in step S12), CPU 31 repeats step S12.

In contrast, when CPU 31 determines that communication with apparatus 100 is indicated (YES in step S12), control unit 302 controls reading unit 303 to read authentication information 307. When reading unit 303 cannot read authentication information 307 from the storage area, reading unit 303 outputs notification indicating ‘unreadable’ to control unit 302. For example, when authentication information 307 is deleted from storage 305, as will be described later, reading unit 303 outputs notification indicating ‘unreadable’ to control unit 302.

On the other hand, when reading unit 303 can read authentication information 307, reading unit 303 outputs to control unit 302 notification indicating ‘readable’ and the read authentication information 307.

Once control unit 302 has received the notification indicating ‘readable’ from reading unit 303, control unit 302 controls first communication control unit 301 to transmit the read authentication information 307 to apparatus 100 (Step S15 in FIG. 7 and FIG. 9). Apparatus 100 receives authentication information 307 (authentication ID 211) from biometric authentication sensor 300, and authenticates a user based on the received authentication information 307 (step S16 of FIG. 9). A user authentication process in apparatus 100 will be described later.

In contrast, when control unit 302 receives notification indicating ‘unreadable’ from reading unit 303, control unit 302 skips a process for transmitting authentication information 307 to apparatus 100. Accordingly, apparatus 100 cannot receive authentication information 307 (or authentication ID 211).

(Setting to Make Authentication Information 307 Unreadable)

With reference to FIG. 8, a process of setting authentication information 307 to be unreadable during connection (or pairing) will be described. The process of FIG. 8 is repeatedly performed during pairing. In the first example of one or more embodiments, when it is detected that biometric authentication sensor 300 and mobile terminal 200 are separated beyond a predetermined distance during pairing, authentication information 307 is set to be unreadable. As a result, biometric authentication sensor 300 is prohibited from transmitting authentication information 307 (authentication ID 211) to apparatus 100 (‘unreadable’ in step S13).

First, based on a strength of a signal received from first communication control unit 301, determination unit 308 determines whether biometric authentication sensor 300 is separated from mobile terminal 200 beyond the predetermined distance (step S17). Specifically, determination unit 308 detects a strength of a signal received from mobile terminal 200 via first communication control unit 301. When determination unit 308 determines that the detected strength received is less than a threshold value, and detects that that determination has continued a predetermined number of times, determination unit 308 determines that biometric authentication sensor 300 and mobile terminal 200 are separated beyond the predetermined distance.

For example, while biometric authentication sensor 300 (or mobile terminal 200) is left on a desk, a user carrying mobile terminal 200 (or biometric authentication sensor 300) with him/her moves, and when a distance between biometric authentication sensor 300 and mobile terminal 200 exceeds a predetermined distance, then, determination unit 308 determines that they are separated (YES in step S17). Control unit 302 sets storage 305 to a state in which authentication information 307 is unreadable (step S18). Specifically, control unit 302 controls writing unit 304 to delete authentication information 307 from the storage area. Writing unit 304 deletes authentication information 307.

When determination unit 308 determines that biometric authentication sensor 300 and mobile terminal 200 are not separated beyond the predetermined distance (NO in step S17), CPU 31 skips a process for setting a state in which authentication information 307 is unreadable (step S18). Thus, when the distance between biometric authentication sensor 300 and mobile terminal 200 is equal to or smaller than the predetermined distance, storage 305 is set to a state in which authentication information 307 is readable, and authentication information 307 can be transmitted to apparatus 100.

It should be noted that the method of setting authentication information 307 to be unreadable is not limited to deleting authentication information 307 from storage 305, as described above. For example, writing unit 304 may overwrite authentication information 307 with another information (null data or the like), or control unit 302 may set reading unit 303 to a state prohibiting reading of authentication information 307.

Thus, in the first embodiment, when it is determined that biometric authentication sensor 300 is separated from mobile terminal 200 beyond a predetermined distance during pairing (YES in step S17), storage 305 is switched to a state in which authentication information 307 (authentication ID 211)is unreadable (step S18). Accordingly, when biometric authentication sensor 300 communicates with apparatus 100, the process for transmitting authentication ID 211 to apparatus 100 (step S15) is skipped, and the user is prohibited from using (or operating) apparatus 100.

In contrast, while it is determined that biometric authentication sensor 300 and mobile terminal 200 are not separated during pairing (NO in step S17), step S18 is skipped and storage 305 remains in a state in which authentication information 307 (authentication ID 211) is readable. Therefore, for example, while the user is carrying both biometric authentication sensor 300 and mobile terminal 200 with him/her and thus biometric authentication sensor 300 and mobile terminal 200 are positionally close to each other, the process for transmitting authentication ID 211 to apparatus 100 (step S15) is performed and the user is permitted to use (or operate) apparatus 100.

(Authentication of User by Apparatus 100)

A user authentication process by apparatus 100 in step S16 of FIG. 9 will be described. CPU 150 of apparatus 100 receives authentication information 307 (authentication ID 211) from biometric authentication sensor 300 via reception unit 159. User authentication unit 174 matches the received authentication information 307 against registered ID 161 in storage 160, and when a result of the matching indicates a match, CPU 150 starts each unit. Thus, when it is determined that the user is a valid user (a user registered with apparatus 100), apparatus 100 permits the user to use (or operate) apparatus 100.

On the other hand, when the result of the matching by user authentication unit 174 does not indicate a match, CPU 150 does not start each unit. Thus, when it is determined that the user is not a valid user of apparatus 100, apparatus 100 prohibits the user from using (or operating) apparatus 100.

(Other Examples of Decision by Determination Unit 308)

In the first example of one or more embodiments, when determination unit 308 determines that biometric authentication sensor 300 is separated from mobile terminal 200 beyond a predetermined distance, determination unit 308 switches a state of storage 305 from an authentication information 307 readable state to an authentication information 307 unreadable state, however, the condition for determining that the switching should be done is not limited to the distance between biometric authentication sensor 300 and mobile terminal 200.

For example, the switching may be done once a timer has measured that a predetermined period of time (e.g., of about 3 minutes equivalent to a screen saver of a PC) has elapsed since authentication ID 211 received from mobile terminal 200 was stored to storage 305 as authentication information 307.

Further, the switching may be done when it is detected from a position sensor's sensed value that the user carrying biometric authentication sensor 300 or mobile terminal 200 with him/her has left a predetermined area (i.e., that positional information of biometric authentication sensor 300 or mobile terminal 200 is outside that area).

Furthermore, during pairing after mobile terminal 200 has transmitted authentication ID 211 to biometric authentication sensor 300, matching unit 206 of mobile terminal 200 may match information of a fingerprint image obtained via sensor 24 against verifying information 210, and based on a result of the matching, the switching may be done. Specifically, when it is determined, as a result of the matching, that both fingerprint images have a similarity less than a predetermined threshold value, CPU 20 transmits a request to biometric authentication sensor 300 to switch a state. In response to the state switching request received from mobile terminal 200, determination unit 308 of biometric authentication sensor 300 switches a state of storage 305 to a state in which authentication information 307 is unreadable. Thus, for example, when a third party who is not a valid user carries mobile terminal 200, a state of storage 305 can be switched to a state in which authentication information 307 is unreadable.

The condition for determining whether or not to switch storage 305 to a state in which authentication information 307 is unreadable can also be a combination of two or more of the above plurality of conditions (i.e., distance, elapsed time, positional information, and similarity).

A second example of one or more embodiments indicates an exemplary variation of the first example of one or more embodiments. While in the first example, mobile terminal 200 obtains biometric information for an authentication process via sensor 24, a route to obtain the biometric information is not limited thereto. In the second example, a biometric authentication sensor 300A obtains biometric information and transmits the obtained biometric information to a mobile terminal 200A for an authentication process.

<Configuration of Biometric Authentication Sensor 300A and Mobile Terminal 200A>

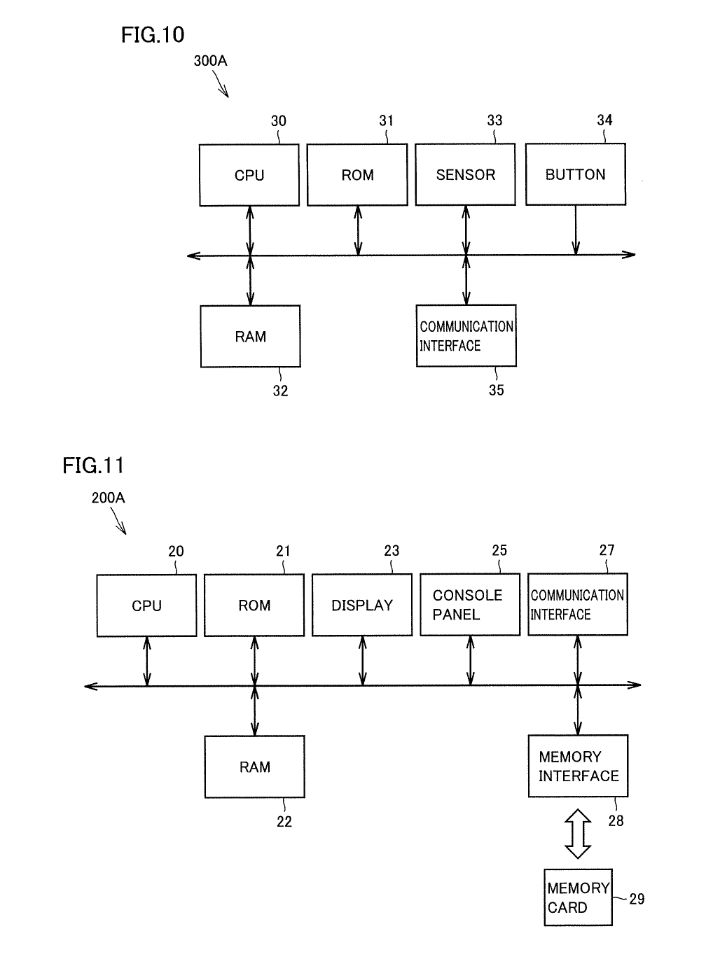

FIG. 10 shows a specific example of a hardware configuration of biometric authentication sensor 300A according to the second example of one or more embodiments. Referring to FIG. 10, biometric authentication sensor 300A includes a sensor 33 for detecting biometric information in addition to the configuration of biometric authentication sensor 300 (see FIG. 2). Sensor 33 is similar in configuration and function to sensor 24. The remainder in configuration of biometric authentication sensor 300A is similar to that shown in FIG. 2, and accordingly it will not be described redundantly.

FIG. 11 shows a specific example of a hardware configuration of mobile terminal 200A according to the second example of one or more embodiments. Referring to FIG. 11, mobile terminal 200A has the configuration of mobile terminal 200 (see FIG. 3) without sensor 24. The remainder in configuration of mobile terminal 200A is similar to that shown in FIG. 3, and accordingly it will not be described redundantly.

<Functional Configuration of Biometric Authentication Sensor 300A and Mobile Terminal 200A>

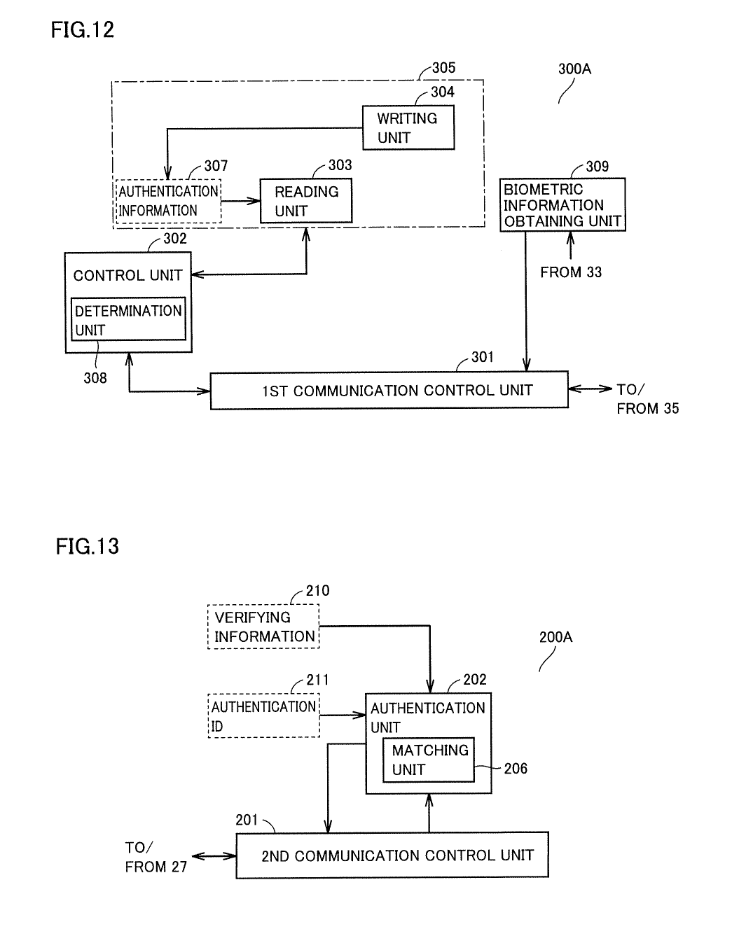

FIG. 12 shows an example of a configuration of a function of biometric authentication sensor 300A according to the second example of one or more embodiments. With reference to FIG. 12, biometric authentication sensor 300A includes the configuration of biometric authentication sensor 300 (see FIG. 5) and in addition thereto a biometric information obtaining unit 309 that obtains biometric information (a fingerprint image) from an output of sensor 33. Biometric information obtaining unit 309 has a function similar to that of biometric information obtaining unit 203, and accordingly it will not be described redundantly. The biometric information obtained by biometric information obtaining unit 309 is transmitted to mobile terminal 200 by first communication control unit 301. The remainder in configuration of biometric authentication sensor 300A is similar to that shown in FIG. 5, and accordingly it will not be described redundantly.

FIG. 13 shows an example of a configuration of a function of mobile terminal 200A according to the second example of one or more embodiments. Referring to FIG. 13, mobile terminal 200A has the configuration of mobile terminal 200 (see FIG. 6) without biometric information obtaining unit 203. The remainder in configuration of mobile terminal 200A of FIG. 13 is similar to that shown in FIG. 6, and accordingly it will not be described redundantly.

<Flowchart of Process>

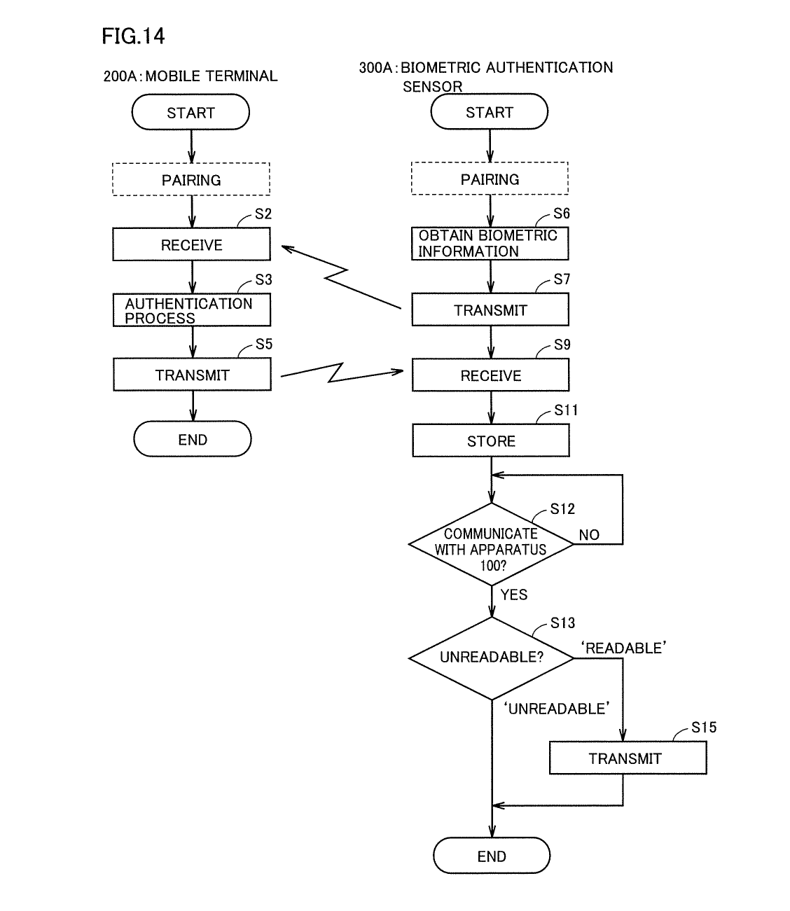

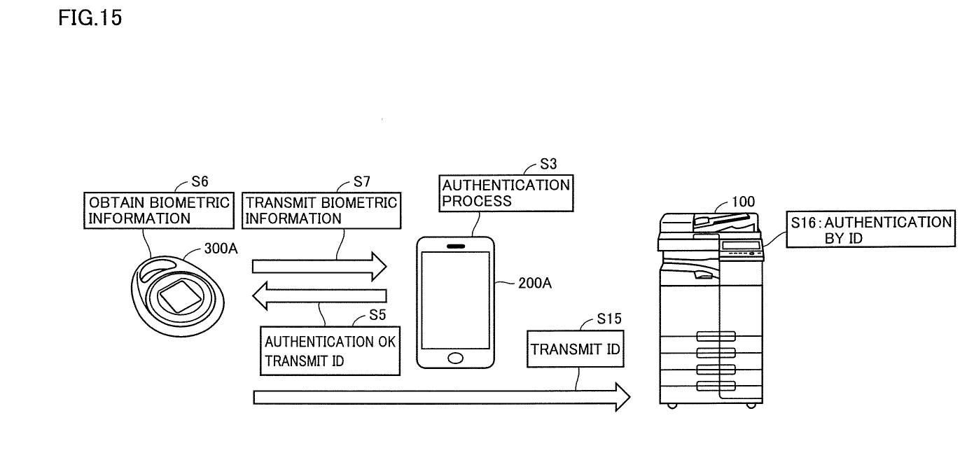

FIG. 14 is a flowchart of an authentication process according to the second example of one or more embodiments. FIG. 15 schematically shows data transmitted and received between devices according to the second example of one or more embodiments. With reference to FIG. 14 to FIG. 15, the authentication process according to the second example of one or more embodiments will be described.

In the second example of one or more embodiments, a biometric authentication sensor 300A obtains biometric information (a fingerprint image) via sensor 33 and transmits the obtained biometric information to mobile terminal 200A. Accordingly, in the flowchart of FIG. 14, first communication control unit 301 of biometric authentication sensor 300A starts pairing with second communication control unit 201 of mobile terminal 200A, and once it has established communication (or connection), sensor 33 of biometric authentication sensor 300A detects biometric information (or fingerprint image) of a user. Biometric information obtaining unit 309 obtains information of the fingerprint image from an output of sensor 33 (step S6 of FIG. 14 and FIG. 15). First communication control unit 301 of biometric authentication sensor 300A transmits the obtained biometric information to mobile terminal 200A (step S7 of FIG. 14 and FIG. 15).

Second communication control unit 201 of mobile terminal 200A receives the biometric information (the information of the fingerprint image) from biometric authentication sensor 300A (step S2 of FIG. 14 and FIG. 15), and authentication unit 202 performs an authentication process with the information of the fingerprint image received (step S3 of FIG. 14 and FIG. 15). In the authentication process, matching unit 206 matches the received fingerprint image against verifying information 210. Based on a similarity between the fingerprint images indicated by a result of the matching process, authentication unit 202 determines whether the fingerprint image obtained via sensor 33 of biometric authentication sensor 300A indicates a fingerprint image of a valid user of mobile terminal 200A.

Authentication unit 202 transmits a result of the authentication process to biometric authentication sensor 300A via second communication control unit 201 (step S5 of FIG. 14 and FIG. 15). The result of the authentication process includes notification indicating “authentication=OK (or NG)” and authentication ID 211. Step S5 is similar to step S5 in FIG. 7, and accordingly, it will not be described redundantly.

In biometric authentication sensor 300A, first communication control unit 301 receives the authentication result of authentication unit 202 from mobile terminal 200A (step S9). When control unit 302 determines that the received information indicates authentication=OK, control unit 302 writes authentication ID 211 included in the received information as authentication information 307 via writing unit 304 to the storage (Step S11). When control unit 302 determines that the received information indicates authentication=NG, the control unit does not perform writing (or storing) the received information.

Thereafter, in biometric authentication sensor 300A, steps S12, S13, and S15 are similarly performed. Steps S12 to S15 are similar to those in FIG. 7 and accordingly, will not be described redundantly.

The user authentication process (step S16) by apparatus 100 in FIG. 15 is similar to a corresponding process in the first example of one or more embodiments, and accordingly, will not be described redundantly.

Thus, in one or more embodiments, in biometric authentication sensor 300A, the process shown in FIG. 8 is performed. Accordingly, when it is determined that biometric authentication sensor 300A is separated from mobile terminal 200A during pairing (YES in step S17 of FIG. 8), storage 305 is switched to a state in which authentication information 307 (authentication ID 211) is unreadable (Step S18 of FIG. 8). Accordingly, when biometric authentication sensor 300A communicates with apparatus 100, the process for transmitting authentication ID 211 to apparatus 100 (step S15) is skipped, and the user is prohibited from using (or operating) apparatus 100.

In contrast, while it is determined that biometric authentication sensor 300A is not separated from mobile terminal 200A during pairing (NO in step S17 of FIG. 8), step S18 is skipped. Accordingly, for example when the user carries both biometric authentication sensor 300A and mobile terminal 200A with him/her, the process for transmitting authentication ID 211 to apparatus 100 (step S15) is performed, and the user is permitted to use (or operate) apparatus 100.

A third example of one or more embodiments indicates an exemplary variation of the first or second example of one or more embodiments. While in the first and second examples of one or more embodiments an input of an instruction indicated by a user operating button 34 or operation panel 25 is used as a trigger to start an authentication process (the process shown in FIG. 7 or FIG. 14), the trigger to start the process is not limited to an input of an instruction by a user operation. For example, the process may be started once a fingerprint image has been sensed via sensor 33 or sensor 24.

Further, for example, the process may be started when pressing by a finger is sensed via sensor 33 or sensor 24. Further, determining whether to start communication with apparatus 100 (step S12) may also be based on whether pressing by a finger is sensed via sensor 33 or sensor 24. Thus, the user can easily instruct biometric authentication sensor 300 (300A) or mobile terminal 200 (200A) to start the process.

A portable terminal is provided in certain embodiments described above. This terminal includes a hardware processor which controls the terminal, a storage, and a communication interface which communicates with an external device. The external device includes an authentication device which performs an authentication process using biometric information of a subject and transmits to the terminal authentication information based on that authentication process for obtaining a permission to operate an apparatus to be operated.

The hardware processor receives the authentication information from the authentication device and stores the received authentication information to the storage, sets the storage to a state in which the authentication information is readable when a predetermined condition is satisfied, and sets the storage to a state in which the authentication information is unreadable when the predetermined condition is unsatisfied.

In a fourth example of one or more embodiments, a program is provided for causing mobile terminal 200 (200A) or biometric authentication sensor 300 (300A) to execute the authentication process of one or more embodiments described above. Such a program at least includes a program according to the flowcharts shown in FIGS. 7, 8 and 14. The program can be non-transiently stored on a flexible disk, a CD-ROM (Compact Disk-Read Only Memory), a ROM, a RAM, a memory card or a similar, computer readable storage medium that is an accessory of a computer of mobile terminal 200 (200A) or biometric authentication sensor 300 (300A), and thus provided as a program product. Alternatively, the program can also be stored non-transiently on a storage medium such as a hard disk incorporated in the computer, and thus provided. Furthermore, the program can also be provided by downloading via a network. The program is executed by one or more hardware processors such as CPU 20 or CPU 30, or by a combination of the hardware processor(s) and another circuit (ASIC, FPGA, etc.).

Note that the program may invoke a required module of program modules provided as a portion of an operating system (OS) of a computer, in a prescribed sequence, as timed as prescribed, and may cause the module to perform a process. In that case, the program per se does not include the above module and cooperates with the OS to perform the process. Such a program that does not include the module can also be included in the program according to the fourth example of one or more embodiments.

Furthermore, the program according to the fourth example of one or more embodiments may be incorporated in and provided as a portion of another program. The program in that case also per se does not include the module(s) included in the other program and cooperates with the other program to perform a process. Such a program incorporated in another program can also be included in the program according to the fourth example of one or more embodiments.

The provided program product is installed in a program storing unit, such as a hard disk, and executed. Note that the program product includes a program per se and a storage medium having the program non-transiently stored thereon.

According to one or more embodiments described above, biometric authentication sensor 300 (300A) is enhanced in usability as biometric authentication sensor 300 (300A) is portable. In addition, biometric authentication sensor 300 (300A) does not perform an authentication process, and is hence relieved of a burden associated with the authentication process.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A portable terminal comprising:
a storage;
a communication interface that communicates with an external device that includes an authentication device;
a sensor that detects a biometric information of a subject; and
a hardware processor that:
transmits the detected biometric information to the authentication device via the communication interface;
receives an authentication information from the authentication device via the communication interface and stores the received authentication information in the storage;
sets the storage to a state where the authentication information is readable when a predetermined condition is satisfied; and
sets the storage to a state where the authentication information is unreadable when the condition is not satisfied,
wherein the authentication device:
executes an authentication process using the biometric information to authenticate the subject, and
transmits, to the terminal, the authentication information to obtain a permission to operate an apparatus.

2. The portable terminal according to claim 1, wherein:
communication by the communication interface is wireless; and
the predetermined condition is based on a strength of a signal received by the terminal from the authentication device.

3. The portable terminal according to claim 1, wherein the predetermined condition is based on a period of time having elapsed since the authentication information was stored to the storage.

4. The portable terminal according to claim 1, wherein the predetermined condition is based on the position of the terminal.

5. The portable terminal according to claim 1, wherein:
the external device further includes the operated apparatus; and
the hardware processor transmits the authentication information read from the storage to the operated apparatus via the communication interface.

6. A method for controlling a portable terminal, the terminal comprises a storage and a communication interface, the method comprising:
communicating with an authentication device via the communication interface, wherein the authentication device:
performs an authentication process using a biometric information of a subject, and transmits to the terminal an authentication information based on the authentication process to obtain a permission to operate an apparatus;
detecting the biometric information of the subject;
transmitting the detected biometric information to the authentication device via the communication interface;
storing the authentication information received from the authentication device in the storage;
in response to a predetermined condition being satisfied, setting the storage to a state where the authentication information is readable; and
in response to the predetermined condition not being satisfied, setting the storage to a state where the authentication information is unreadable.

7. The method according to claim 6, wherein:
a communication by the communication interface is wireless; and
the predetermined condition is based on a strength of a signal received by the terminal from the authentication device.

8. The method according to claim 6, wherein the predetermined condition is based on a period of time having elapsed since the authentication information was stored to the storage.

9. The method according to claim 6, wherein the predetermined condition is based on the position of the terminal.

10. The method according to claim 6, further comprising transmitting the authentication information read from the storage to the apparatus via the communication interface.

11. A storage medium having a program non-transiently stored thereon for causing a computer processor to execute a method for controlling a portable terminal, the terminal comprises a storage and a communication interface, the executed method comprising:
communicating with an authentication device via the communication interface, wherein the authentication device:
performs an authentication process using a biometric information of a subject, and
transmits to the terminal an authentication information based on the authentication process to obtain a permission to operate an apparatus;
detecting the biometric information of the subject;
transmitting the detected biometric information to the authentication device via the communication interface;
storing the authentication information received from the authentication device in the storage;
in response to a predetermined condition being satisfied, setting the storage to a state where the authentication information is readable; and
in response to the predetermined condition not being satisfied, setting the storage to a state where the authentication information is unreadable.

12. The storage medium according to claim 11, wherein:
a communication by the communication interface is wireless; and
the predetermined condition is based on a strength of a signal received by the terminal from the authentication device.

13. The storage medium according to claim 11, wherein the predetermined condition is based on a period of time having elapsed since the authentication information was stored to the storage.

14. The storage medium according to claim 11, wherein the predetermined condition is based on the position of the terminal.

15. The storage medium according to claim 11, wherein the executed method further comprises transmitting the authentication information read from the storage to the apparatus via the communication interface.
